(19) United States
(12) Patent Application Publication
(10) Pub. No.: US 2017/0285890 A1
(43) Pub. Date: Oct. 5, 2017

(54) CONTEXTUAL ACTIONS FROM COLLABORATION FEATURES

(71) Applicant: Microsoft Technology Licensing, LLC, Redmond, WA (US)

(72) Inventor: Elizabeth Brooks Dolman, Cambridge, MA (US)

(21) Appl. No.: 15/282,393

(22) Filed: Sep. 30, 2016

Related U.S. Application Data
(60) Provisional application No. 62/315,160, filed on Mar. 30, 2016.

(51) Int. Cl. G06F 3/0482; H04L 29/06

(52) U.S. Cl. CPC G06F 3/0482; H04L 65/403; G06F 17/24

(57) ABSTRACT

Aspects of the present disclosure relate to systems and methods for providing contextual actions from collaboration features. In one aspect, rendering of a file created with an application in a user interface may be initiated. The file may include at least one collaboration feature. In response to receiving an indication of interest made with respect to the at least one collaboration feature, one or more actions having a contextual relevance to the at least one collaboration feature may be identified. The one or more identified actions may be surfaced in an action hub. For example, the action hub may be displayed within the file proximal to the at least one collaboration feature and may include the one or more identified actions.

### CROSS-REFERENCE TO RELATED APPLICATION(S)

This application a Non-Provisional patent application of, and claims priority to U.S. Provisional Patent Application No. 62/315,160, filed Mar. 30, 2016, entitled “CONTEXTUAL ACTIONS FROM COLLABORATION FEATURES,” which application is incorporated herein by reference in its entirety.

### BACKGROUND

Current applications for processing information such as word processing applications, spreadsheet applications, and electronic slide presentation applications, may facilitate co-authoring and collaborating among users of the applications. In this regard, features of the applications may be used to co-author and collaborate among users of the application. The features may include co-author/collaborator information such as a name of the co-author/collaborator. Current techniques for identifying information associated with a co-author/collaborator include providing a contact card that includes information about the co-author/collaborator. However, these contact cards provide an overwhelming amount of information. As such, current techniques for identifying information associated with a co-author/collaborator and/or invoking an action associated therewith result in an overwhelming amount of data that is distracting, duplicated, cluttered, and difficult to parse.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for providing contextual actions from collaboration features. In one aspect, rendering of file created with a collaboration application in a user interface may be initiated. The file may include at least one collaboration feature. At least one of collaborator information and status information may be surfaced in a first portion of an action hub. One or more actions having a contextual relevance to the at least one collaboration feature may be surfaced in a second portion of the action hub. The action hub may be displayed proximal to the at least one collaboration feature.

In another aspect, rendering of a file created with an application in a user interface may be initiated. The file may include at least one collaboration feature. In response to receiving an indication of interest made with respect to the at least one collaboration feature, one or more actions having a contextual relevance to the at least one collaboration feature may be identified. The one or more identified actions may be surfaced in an action hub.

In yet another aspect, a collaboration application comprises a file in a user interface for collaborating among a plurality of collaborators of the file. The collaboration application may further comprise a first collaboration feature in the user interface through which to present at least metadata associated with at least one of the collaborators of the plurality of collaborators of the file and through which to receive an indication of interest made with respect to the first collaboration feature. The collaboration application may further comprise a first action hub in the user interface through which to, in response to the indication of interest made with respect to the first collaboration feature, surface one or more actions having a contextual relevance to the first collaboration feature.

### DESCRIPTION OF THE DRAWINGS

The detailed description is made with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary action hub system for providing contextual actions from collaboration features, according to an example aspect.

FIG. 2A illustrates one view in a progression of views a word processing application displayed on a user interface of a client computing device, according to an example aspect.

FIG. 2B illustrates another view in a progression of views of the word processing application of FIG. 2A, according to an example aspect.

FIG. 2C illustrates another view in the progression of views of the word processing application of FIG. 2A, according to an example aspect.

FIG. 2D illustrates another view in the progression of views of the word processing application of FIG. 2A, according to an example aspect.

FIG. 2E illustrates another view in the progression of view of the word processing application of FIG. 2A, according to an example aspect.

FIG. 3 illustrates an exemplary method for providing contextual actions from collaboration features, according to an example aspect.

FIG. 4 illustrates a computing system suitable for implementing the enhanced action hub technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to providing contextual actions from collaboration features. For example, a file such as a word processing file created by a collaboration application may include a plurality of collaboration features such as a collaborator gallery, a list of collaborators with whom to share the file, activities associated with the file, comments, and the like. Each of the plurality of collaboration features of the file may be used to facilitate collaborating and/or co-authoring between a user and the co-authors/collaborators of the file. For example, a user of the file may want to quickly share the file with a collaborator and set and/or change permissions of the collaborator relative to the file. In this regard, the sharing collaboration feature may include an action for setting and/or changing the permissions of the collaborator with whom the file is shared. In one example, when a user shares the file with another co-author/collaborator, the user may initiate an indication of interest with respect to the co-author/collaborator from the share list collaboration feature. In response to initiating the indication of interest with respect to the co-author/collaborator from the share list collaboration feature, a permissions action may be surfaced in an action hub proximal to the share list collaboration feature. In this regard, when a file is shared with a co-author/collaborator, the user of the file may easily and efficiently set permissions of the co-author/collaborator relative to the file such as whether the co-author/collaborator may edit the file or only view the file.

As discussed above, current techniques for identifying information associated with a co-author/collaborator include providing a contact card that includes information about the co-author/collaborator. However, these contact cards provide an overwhelming amount of information. As such, current techniques for identifying information associated with a co-author/collaborator and/or invoking an action associated therewith result in an overwhelming amount of data that is distracting, duplicated, cluttered, and difficult to parse.

Accordingly, aspects described herein include techniques that make identifying information associated with a co-author/collaborator and/or invoking an action have contextual relevance to a collaboration feature intuitive, user-friendly, and efficient. In one aspect, rendering of a file created with a collaboration application in a user interface may be initiated. The file may include at least one collaboration feature. In one example, the at least one collaboration feature may include at least one of a collaborator gallery, a share list, a comment, an activity, a chat, and a self-identity. In response to receiving an indication of interest with respect to the at least one collaboration feature, at least one of collaborator information and status information may be surfaced in a first portion of an action hub and one or more actions having a contextual relevance to the at least one collaboration feature may be surfaced in a second portion of the action hub. In one example, the one or more actions include at least one of a communication action, an edit action, a collaborator profile action, a permissions action, a filter action, and an account action. In one case, the action hub is displayed proximal to the at least one collaboration feature. In this regard, a user may quickly, intuitively, and efficiently identify and invoke any actions they may need to take while collaborating within applications.

As such, a technical effect that may be appreciated is that one or more actions having a contextual relevance to at least one collaboration feature may be surfaced in an action hub within a file in a clear and understandable manner and on a functional surface. In turn, collaboration on documents may be accomplished in a faster and/or more efficient manner, ultimately reducing processor load, conserving memory, and reducing network bandwidth usage. Another technical effect that may be appreciated is that users and/or co-authors/collaborators of a file may quickly, easily, and efficiently view those actions that are most relevant to them based on the contextual feature, as well as invoke any actions they may need to take while collaborating within applications. Yet another technical effect that may be appreciated is that surfacing one or more actions having a contextual relevance to a collaboration feature facilitates a compelling visual and functional experience to allow a user to efficiently interact with a user interface for collaborating and/or co-authoring within applications.

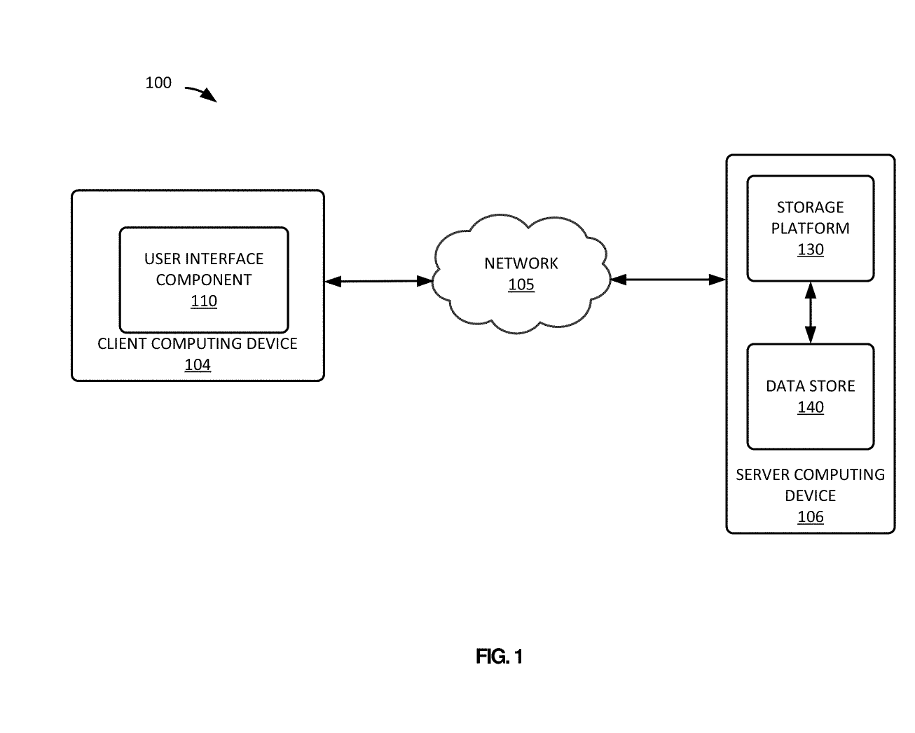

Referring now to the drawings, in which like numerals represent like elements through the several figures, aspects of the present disclosure and the exemplary operating environment will be described. With reference to FIG. 1, one aspect of an action hub system 100 for providing contextual actions from collaboration features is illustrated. The action hub system 100 may include a client computing device 104 and a server computing device 106. In aspects, the action hub system 100 may be implemented on the client computing device 104. In a basic configuration, the client computing device 104 is a handheld computer having both input elements and output elements. The client computing device 104 may be any suitable computing device for implementing the action hub system 100 for providing contextual actions from collaboration features. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device 104 for implementing the action hub system 100 for providing contextual actions from collaboration features may be utilized.

In aspects, the action hub system 100 may be implemented on the server computing device 106. The server computing device 106 may provide data to and from the client computing device 104 through a network 105. In aspects, the action hub system 100 may be implemented on more than one server computing device 106, such as a plurality of server computing devices 106. As discussed above, the server computing device 106 may provide data to and from the client computing device 104 through the network 105. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As discussed above, the action hub system 100 may include the client computing device 104 and the server computing device 106. The various components may be implemented using hardware, software, or a combination of hardware and software. In aspects, the client computing device 104 may include a user interface component 110. The user interface component 110 may facilitate providing contextual actions from collaboration features. For example, the user interface component 110 may initiate rendering of a file created with a collaboration application in a user interface of the client computing device 104. In one example, a collaboration application may include any application suitable for collaboration and/or co-authoring such as a word processing application, spreadsheet application, electronic slide presentation application, email application, chat application, voice application, and the like. In one case, a file associated with and/or created with the application may include a word document, a spreadsheet, an electronic slide presentation, an email, a chat conversation, and the like. As such, an exemplary application may be an electronic slide presentation application. In this example, an exemplary file associated with the electronic slide presentation application may include an electronic slide presentation.

In another example, the file may include at least one collaboration feature. In one example, the at least one collaboration feature may include at least one of a collaborator gallery, a share list, a comment, an activity, a chat, and a self-identity. The collaborator gallery may include one or more co-author icons that identify co-authors/collaborators who are active in the file. In one example, the one or more co-author icons may include an image (e.g., a photo of the co-author/collaborator). The share list may include a list of co-authors/collaborators with whom the file has been shared. The comment may include one or more comments made relative to the file. The activity may include one or more activities associated with the file. For example, the one or more activities may include may include content changes, communication activities, document content exchanges, permission requests, sharing, printing, and the like. The chat may include a communication and/or messaging application such as Instant Messaging. The self-identity may include a self-identifier for identifying the current user of the file (e.g., a name and/or photo).

In one aspect, the user interface component 110 and/or the file rendered on the user interface may surface at least one of collaborator information and status information in a first portion of an action hub. For example, in response to receiving an indication of interest made with respect to the at least one collaboration feature, the action hub may be invoked and displayed within the file. In one example, the action hub is displayed proximal to the at least one collaboration feature. In one case, the action hub is a user interface element for surfacing and/or displaying information associated with co-authors/collaborators of the file and/or one or more actions having a contextual relevance to the at least one collaboration feature. In this regard, the action hub may include at least the collaborator information and the status information. In one example, the indication of interest made with respect to the at least one collaboration feature is made with respect to a collaborator associated with the at least one collaboration feature. In some cases, the collaborator information includes at least a collaborator image and a collaborator identifier. The collaborator image may include an image (e.g., a photo) of the collaborator associated with the at least one collaboration feature. The collaborator identifier may identify the collaborator associated with the at least one collaboration feature. In one example, the collaborator identifier is a name of the collaborator associated with the at least one collaboration feature. In some examples, the status information may include an editing status. The editing status may indicate that the collaborator associated with the at least one collaboration feature is editing the file. In one example, the editing status may include editing location information such as the page number in a file that is being edited. In another example, the editing status may include editing information such as a device on which the file is being edited. In another example, the editing status may indicate that edits to the file show up immediately. For example, the editing status may include a status such as, “Sharing live edits.” In this case, the file may be shared such that the live edits from another collaborator are not viewable.

In another aspect, the user interface component 110 and/or the file rendered on the user interface may surface one or more actions having a contextual relevance to the at least one collaboration feature in a second portion of the action hub. For example, in response to receiving an indication of interest made with respect to the at least one collaboration feature, the action hub may be invoked and displayed within the file. In this regard, the action hub may include at least the one or more actions having a contextual relevance to the at least one collaboration feature. The one or more actions having a contextual relevance to the at least one collaboration feature are those actions that are related to and/or specific to a collaboration feature. For example, an action that a user/collaborator of the file would want to take relative to a collaboration feature may be related to and/or specific to the collaboration feature. In one case, the one or more actions include at least one of a communication action, a go-to action, a collaborator profile action, a permissions action, a filter action, and an account action. In one example, the communication action may include email and/or chat communications. For example, a user/collaborator of the file may email another user/collaborator of the file in view of a collaboration feature. In one example, the go-to action may take the user of the file invoking the go-to action to a location of the file where another user/collaborator of the file is making edits to the file. In one example, the collaborator profile action may facilitate viewing of contact information associated with another collaborator. For example, when a user invokes the collaborator profile action, a contact card may be displayed within the file. In one example, the permissions action may allow a user of the file to set and/or change permissions of another collaborator associated with the file. For example, a user may change the permissions of another collaborator from viewing the file to editing the file (e.g., the permissions are changed to allow the other collaborator to edit the file). In one example, the filter action may be associated with the activity collaboration feature. In one case, the filter action may allow a user of the file to filter an activity pane including one or more activities to display only those activities of another collaborator associated with the activity collaboration feature. In one example, the account action may allow a user of the file to change and/or view his/her account settings and/or account information.

In one example, the user interface component 110 may be a touchable user interface that is capable of receiving input via contact with a screen of the client computing device 104, thereby functioning as both an input device and an output device. For example, content may be displayed, or output, on the screen of the client computing device 104 and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component 110 may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device 104, thereby functioning as both an input device and an output device. For example, content may be displayed, or output, on the screen of the client computing device 104 and input may be received by contacting the screen using a cursor, for example. In this regard, contact may include, for example, placing a cursor on the non-touchable user interface using a device such as a mouse.

In some aspects, the server computing device 106 may include a storage platform 130 and the data store 140. In one example, the storage platform 130 may be configured to store, manage, and access data and/or information associated with the action hub system 100. For example, the storage platform 130 may store one or more files and/or one or more activities associated with a file in a data store 140. In one example, data store 140 may be part of and/or located at the storage platform 130. In another example, data store 140 may be a separate component and/or may be located separate from the storage platform 130. It is appreciated that although one server computing device 106 is illustrated in FIG. 1, the action hub system 100 may include a plurality of server computing devices 106 with a plurality of storage platforms 130 and a plurality of data stores 140. In some cases, the server computing device 106 may include a plurality of storage platforms 130 and a plurality of data stores 140. For example, the plurality of storage platforms 130 may include at least file storage providers, external activity services and document editing clients. In one example, the storage platform 130 may be a cloud storage service such as OneDrive, SharePoint, Google Drive, Dropbox, and the like.

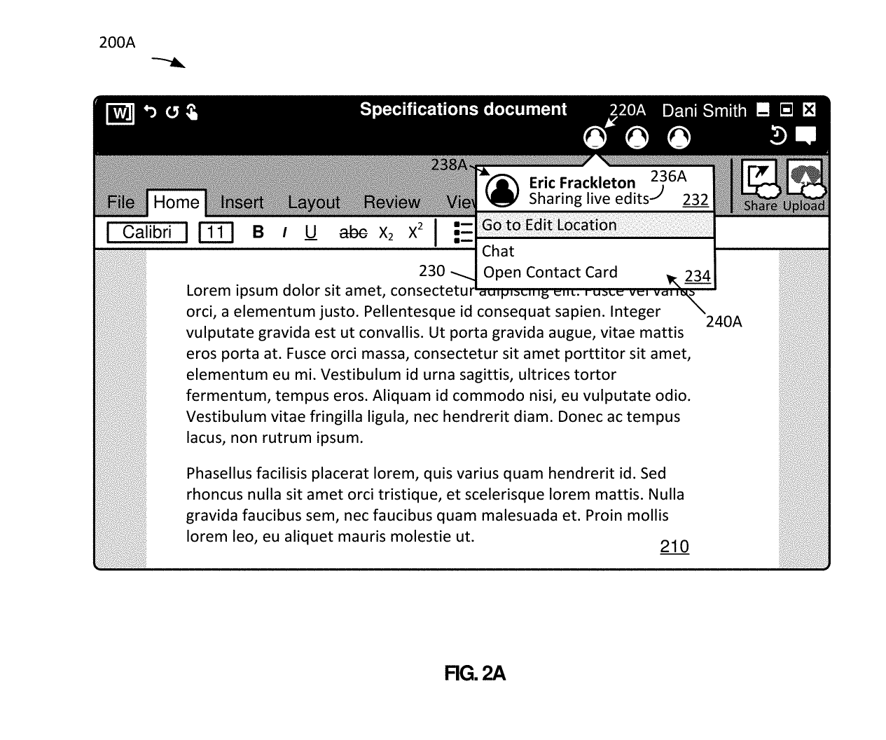

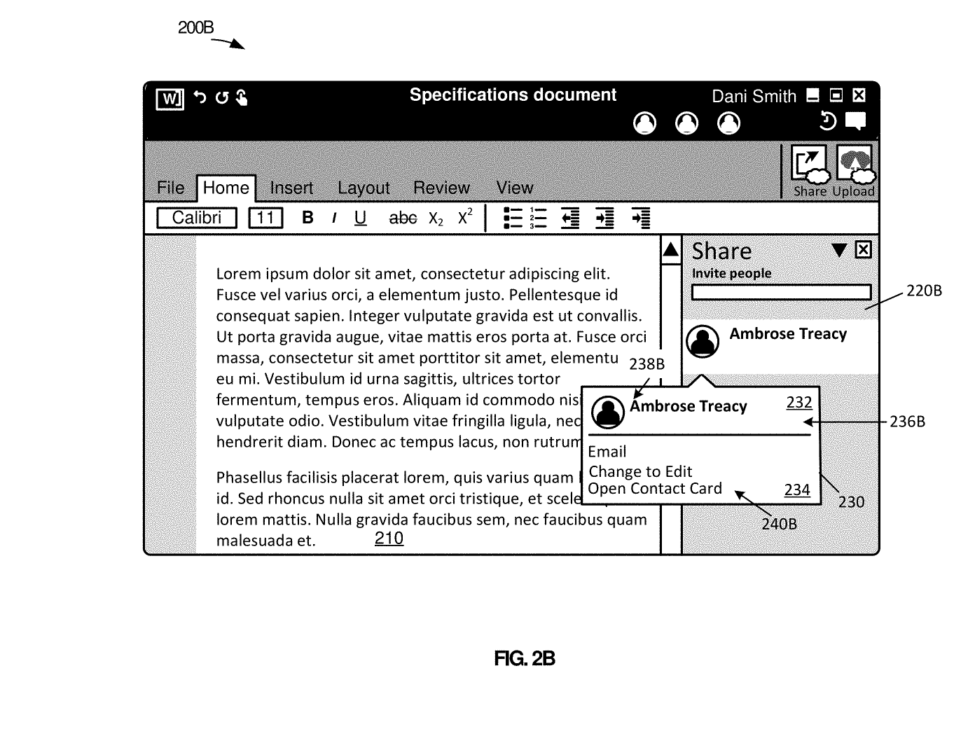

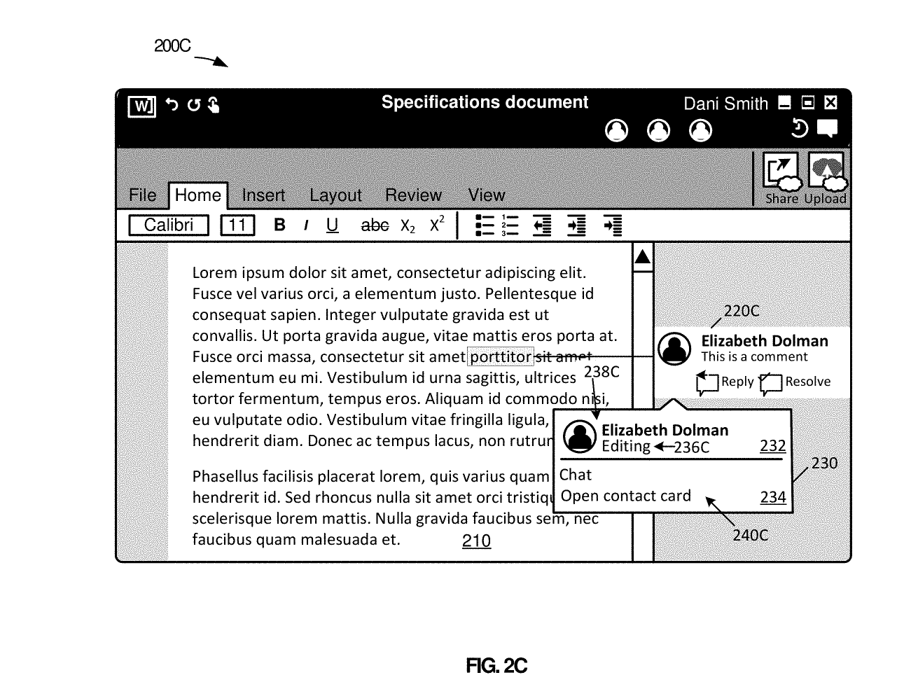

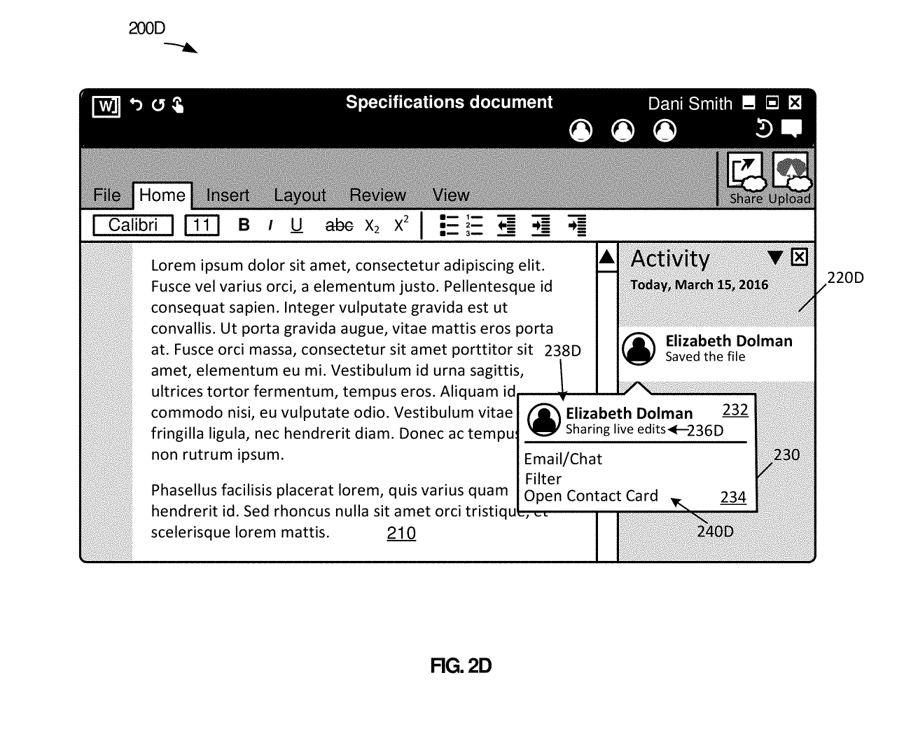

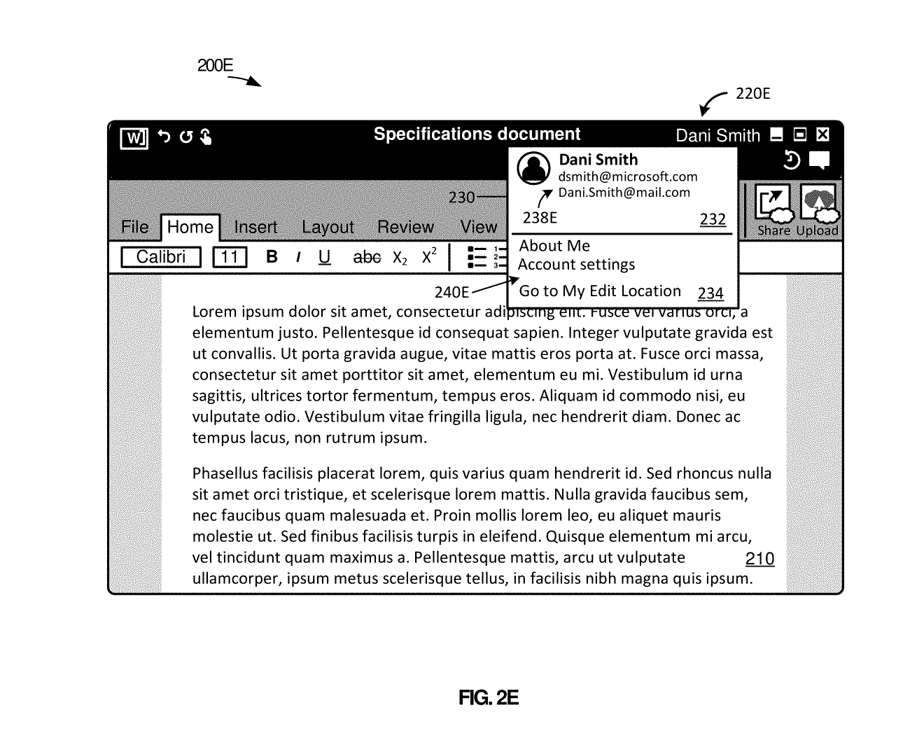

Referring now to FIG. 2A, one view 200A in a progression of views of a word processing application displayed on a user interface of the client computing device 104, such as a desktop computer, tablet computer or a mobile phone, for example, is shown. The exemplary application, as shown in FIG. 2A, is a word processing application. In one example, an application may include any information processing application suitable for collaboration and/or co-authoring such as a word processing application, spreadsheet application, and electronic slide presentation application. In one case, a file associated with the application may include a word document, a spreadsheet, and/or an electronic slide presentation. As such, an exemplary application may be a word processing application, as illustrated in FIG. 2A. In this example, an exemplary file associated with the word processing application may include a word document.

As illustrated, the exemplary view 200A of the word processing application displayed on the client computing device 104 includes a file 210, a collaboration feature 220A, and an action hub 230. The collaboration feature 220A illustrated in FIG. 2A is a collaborator gallery. As illustrated in FIG. 2A, the collaboration feature 220A (e.g., the collaborator gallery) includes three co-author icons that identify the co-authors/collaborators who are active in the file. In one example, the one or more co-author icons may include an image (e.g., a photo of the co-author/collaborator). In this regard, in response to receiving an indication of interest made with respect to the collaboration feature 220A, the action hub 230 may be invoked and displayed within the file 210, as illustrated in FIG. 2A. In one example, an indication of interest may include touching, clicking on, audibly referencing, pointing to, selecting, and/or any indication of an interest in or selection of the collaboration feature 220A. The action hub 230 includes a first portion 232 and a second portion 234. As illustrated in FIG. 2A, the first portion 232 of the action hub 230 is located in a top portion of the action hub 230 and the second portion 234 of the action hub 230 is located in a bottom portion of the action hub 230. The first portion 232 of the action hub 230 includes collaborator information 238A and status information 236A. The collaborator information 238A may include metadata associated with at least one of the collaborator of the file. For example, the collaborator information 238A includes a collaborator image and a collaborator identifier. The collaborator identifier illustrated in FIG. 2A is “Eric Frackleton.” In this regard, Eric Frackleton is the collaborator associated with the first co-author icon of the collaboration feature 220A (e.g., the collaborator gallery). As illustrated in FIG. 2A, the indication of interest is made with respect to the first co-author icon of the collaborator gallery (e.g., 220A). The status information 236A associated with co-author/collaborator Eric Frackleton is “Sharing live edits.” The “Sharing live edits” status indicates that Eric Frackleton is editing the file 210 in real-time.

As illustrated in FIG. 2A, the second portion 234 of the action hub 230 includes three actions 240A having a contextual relevance to the collaboration feature 220A. In some examples, the action hub 230 includes three or less actions 240A. In this regard, a user of the file 210 may quickly, easily, and efficiently view those actions that are most of relevant to them based on the contextual feature, as well as invoke any actions they may need to take while collaborating within applications. The three actions 240A include Go to Edit Location, Chat, and Open Contact Card. In one scenario, as illustrated in FIG. 2A, when the collaboration feature 220A is the collaborator gallery, the one or more actions 240A surfaced in the second portion 234 of the action hub 230 include an edit action (e.g., Go to Edit Location), a communication action (e.g., Chat), and a collaborator profile action (e.g., Open Contact Card). In response to receiving a selection of one of the three actions 240A, the selected action may be invoked. For example, in response to receiving a selection of the Go to Edit Location action, as illustrated in FIG. 2A, the word processing application may change the display of the file 210 such that the location in the file 210 where the collaborator (e.g., Erik Frackleton) is making edits is displayed and viewable by the user of the file 210. In one example, the location is where the cursor of the collaborator (e.g., Erik Frackleton) is located in the file 210. In another example, in response to receiving a selection of the Chat action, a communication and/or messaging application such as Instant Messaging may be invoked. In yet another example, in response to receiving a selection of the Open Contact Card action, a contact card including contact information associated with the collaborator (e.g., Erik Frackleton) may be displayed. The contact information may include a phone number, email address, and the like, of the collaborator.

It is appreciated that while FIG. 2A illustrates the word processing application, file 210, collaboration feature 220A, action hub 230, status information 236A, collaborator information 238A, and actions 240A, the discussion of the word processing application, file 210, collaboration feature 220A, action hub 230, status information 236A, collaborator information 238A, and actions 240A is exemplary only and should not be considered as limiting. Any suitable number and/or type of applications, files, collaboration features, action hubs, status information, collaborator information, and actions may be utilized in conjunction with the present disclosure.

Referring now to FIG. 2B, one view 200B in a progression of views of a word processing application displayed on a user interface of the client computing device 104, such as a desktop computer, tablet computer or a mobile phone, for example, is shown. The exemplary application, as shown in FIG. 2B, is a word processing application. As illustrated, the exemplary view 200B of the word processing application displayed on the client computing device 104 includes the file 210, a collaboration feature 220B, and the action hub 230. The collaboration feature 220B illustrated in FIG. 2B is a share list. As illustrated in FIG. 2B, the collaboration feature 220B (e.g., the share list) includes a list of co-authors/collaborators with whom the file has been shared. In this example, the share list includes one co-author/collaborator with whom the file has been shared. In this regard, in response to receiving an indication of interest made with respect to the collaboration feature 220B, the action hub 230 may be invoked and displayed within the file 210, as illustrated in FIG. 2B. In one example, an indication of interest may include touching, clicking on, audibly referencing, pointing to, selecting, and/or any indication of an interest in or selection of the collaboration feature 220B. The action hub 230 includes a first portion 232 and a second portion 234. As illustrated in FIG. 2B, the first portion 232 of the action hub 230 is located in a top portion of the action hub 230 and the second portion 234 of the action hub 230 is located in a bottom portion of the action hub 230. The first portion 232 of the action hub 230 includes collaborator information 238B and status information 236B. The collaborator information 238B may include metadata associated with at least one of the collaborator of the file. For example, the collaborator information 238B includes a collaborator image and a collaborator identifier. The collaborator identifier illustrated in FIG. 2B is “Ambrose Treacy.” As illustrated in FIG. 2B, the indication of interest is made with respect to the collaborator “Ambrose Treacy” of the share list (e.g., 220B). The status information 236B associated with co-author/collaborator Ambrose Treacy is “None”. For example, in some cases, the action hub 230 may surface only collaborator information 238B in the first portion 232 of the action hub 230.

As illustrated in FIG. 2B, the second portion 234 of the action hub 230 includes three actions 240B having a contextual relevance to the collaboration feature 220B. In some examples, the action hub 230 includes three or less actions 240B. In this regard, a user of the file 210 may quickly, easily, and efficiently view those actions that are most of relevant to them based on the contextual feature, as well as invoke any actions they may need to take while collaborating within applications. The three actions 240B include Email, Change to Edit, and Open Contact Card. In one scenario, when the collaboration feature 220B is the share list, the one or more actions 240B surfaced in the second portion 234 of the action hub 230 include a communication action (e.g., Email), a permissions action (e.g., Change to Edit), and a collaborator profile action (e.g., Open Contact Card). In response to receiving a selection of one of the three actions 240B, the selected action may be invoked. For example, in response to receiving a selection of the Email action, an Email application such as Outlook may be invoked. In another example, in response to receiving a selection of the Change to Edit action, the permissions associated with the collaborator Ambrose Treacy may be changed to Edit permissions. For example, in response to invoking the Change to Edit action, Ambrose Treacy can edit the file 210. In other examples, the permissions action may include Change to View and Remove Permissions actions (not illustrated). In yet another example, in response to receiving a selection of the Open Contact Card action, a contact card including contact information associated with the collaborator (e.g., Ambrose Treacy) may be displayed. The contact information may include a phone number, email address, and the like, of the collaborator.

It is appreciated that while FIG. 2B illustrates the word processing application, file 210, collaboration feature 220B, action hub 230, status information 236B, collaborator information 238B, and actions 240B, the discussion of the word processing application, file 210, collaboration feature 220B, action hub 230, status information 236B, collaborator information 238B, and actions 240B is exemplary only and should not be considered as limiting. Any suitable number and/or type of applications, files, collaboration features, action hubs, status information, collaborator information, and actions may be utilized in conjunction with the present disclosure.

Referring now to FIG. 2C, one view 200C in a progression of views of a word processing application displayed on a user interface of the client computing device 104, such as a desktop computer, tablet computer or a mobile phone, for example, is shown. The exemplary application, as shown in FIG. 2C, is a word processing application. As illustrated, the exemplary view 200C of the word processing application displayed on the client computing device 104 includes the file 210, a collaboration feature 220C, and the action hub 230. The collaboration feature 220C illustrated in FIG. 2C is a comment. As illustrated in FIG. 2C, the collaboration feature 220C (e.g., the comment) is a comment made by collaborator “Elizabeth Dolman.” In this regard, in response to receiving an indication of interest made with respect to the collaboration feature 22CA, the action hub 230 may be invoked and displayed within the file 210, as illustrated in FIG. 2C. In one example, an indication of interest may include touching, clicking on, audibly referencing, pointing to, selecting, and/or any indication of an interest in or selection of the collaboration feature 220C. The action hub 230 includes a first portion 232 and a second portion 234. As illustrated in FIG. 2C, the first portion 232 of the action hub 230 is located in a top portion of the action hub 230 and the second portion 234 of the action hub 230 is located in a bottom portion of the action hub 230. The first portion 232 of the action hub 230 includes collaborator information 238C and status information 236C. The collaborator information 238C may include metadata associated with at least one of the collaborator of the file. For example, the collaborator information 238C includes a collaborator image and a collaborator identifier. The collaborator identifier illustrated in FIG. 2C is “Elizabeth Dolman.” In this regard, Elizabeth Dolman is the collaborator associated with the collaboration feature 220C (e.g., the comment). As illustrated in FIG. 2C, the indication of interest is made with respect to the comment (e.g., 220C). The status information 236C associated with co-author/collaborator Elizabeth Dolman is “Editing.” The “Editing” status indicates that Elizabeth Dolman is currently editing the file 210.

As illustrated in FIG. 2C, the second portion 234 of the action hub 230 includes two actions 240C having a contextual relevance to the collaboration feature 22C. In some examples, the action hub 230 includes three or less actions 240C. In this regard, a user of the file 210 may quickly, easily, and efficiently view those actions that are most of relevant to them based on the contextual feature, as well as invoke any actions they may need to take while collaborating within applications. The two actions 240C include Chat and Open Contact Card. In one scenario, as illustrated in FIG. 2C, when the collaboration feature 220C is the comment, the one or more actions 240C surfaced in the second portion 234 of the action hub 230 include a communication action (e.g., Chat), and a collaborator profile action (e.g., Open Contact Card). In response to receiving a selection of one of the two actions 240C, the selected action may be invoked. For example, in response to receiving a selection of the Chat action, a communication and/or messaging application such as Instant Messaging may be invoked. In yet another example, in response to receiving a selection of the Open Contact Card action, a contact card including contact information associated with the collaborator (e.g., Elizabeth Dolman) may be displayed. The contact information may include a phone number, email address, and the like, of the collaborator.

It is appreciated that while FIG. 2C illustrates the word processing application, file 210, collaboration feature 220C, action hub 230, status information 236C, collaborator information 238C, and actions 240C, the discussion of the word processing application, file 210, collaboration feature 220C, action hub 230, status information 236C, collaborator information 238C, and actions 240C is exemplary only and should not be considered as limiting. Any suitable number and/or type of applications, files, collaboration features, action hubs, status information, collaborator information, and actions may be utilized in conjunction with the present disclosure.

Referring now to FIG. 2D, one view 200D in a progression of views of a word processing application displayed on a user interface of the client computing device 104, such as a desktop computer, tablet computer or a mobile phone, for example, is shown. The exemplary application, as shown in FIG. 2D, is a word processing application. As illustrated, the exemplary view 200D of the word processing application displayed on the client computing device 104 includes the file 210, a collaboration feature 220D, and an action hub 230. The collaboration feature 220D illustrated in FIG. 2D is an activity. As illustrated in FIG. 2D, the collaboration feature 220D (e.g., the activity) is a file saving activity by collaborator Elizabeth Dolman. In this regard, in response to receiving an indication of interest made with respect to the collaboration feature 220D, the action hub 230 may be invoked and displayed within the file 210, as illustrated in FIG. 2D. In one example, an indication of interest may include touching, clicking on, audibly referencing, pointing to, selecting, and/or any indication of an interest in or selection of the collaboration feature 220D. The action hub 230 includes a first portion 232 and a second portion 234. As illustrated in FIG. 2D, the first portion 232 of the action hub 230 is located in a top portion of the action hub 230 and the second portion 234 of the action hub 230 is located in a bottom portion of the action hub 230. The first portion 232 of the action hub 230 includes collaborator information 238D and status information 236D. The collaborator information 238D may include metadata associated with at least one of the collaborator of the file. For example, the collaborator information 238D includes a collaborator image and a collaborator identifier. The collaborator identifier illustrated in FIG. 2D is “Elizabeth Dolman.” In this regard, Elizabeth Dolman is the collaborator associated with the collaboration feature 220D (e.g., the activity). As illustrated in FIG. 2D, the indication of interest is made with respect to the activity (e.g., 220D). The status information 236D associated with co-author/collaborator Elizabeth Dolman is “Sharing live edits.” The “Sharing live edits” status indicates that Elizabeth Dolman is editing the file 210 in real-time.

As illustrated in FIG. 2D, the second portion 234 of the action hub 230 includes three actions 240D having a contextual relevance to the collaboration feature 220D. In some examples, the action hub 230 includes three or less actions 240D. In this regard, a user of the file 210 may quickly, easily, and efficiently view those actions that are most of relevant to them based on the contextual feature, as well as invoke any actions they may need to take while collaborating within applications. The three actions 240D include Email/Chat, Filter, and Open Contact Card. In one scenario, as illustrated in FIG. 2D, when the collaboration feature 220D is an activity, the one or more actions 240D surfaced in the second portion 234 of the action hub 230 include a communication action (e.g., Email/Chat), a filter action (e.g., Filter, “See Elizabeth's Activities”), and a collaborator profile action (e.g., Open Contact Card). In response to receiving a selection of one of the three actions 240D, the selected action may be invoked. For example, in response to receiving a selection of the Chat action, a communication and/or messaging application such as Instant Messaging may be invoked. In some examples, the Chat action is surfaced when a user is available on Instant Messaging. In response to receiving a selection of the Email action, an Email application such as Outlook may be invoked. In another example, in response to receiving a selection of the filter action, only those activities performed by Elizabeth Dolman may be displayed within the activity pane. In yet another example, in response to receiving a selection of the Open Contact Card action, a contact card including contact information associated with the collaborator (e.g., Elizabeth Dolman) may be displayed. The contact information may include a phone number, email address, and the like, of the collaborator. In some examples, the activity may include a @mention activity. For example, a collaborator may mention another collaborator when making a comment to the file 210. In this scenario, one of the one or more actions 240D surfaced in the action hub 230 may include See @mention. In response to receiving a selection of the See @mention action, the word processing application may display the location of the file 210 where the @mention comment is made within the file 210. In this regard, the current user of the file 210 may quickly identify where in the file 210 he/she is mentioned.

It is appreciated that while FIG. 2D illustrates the word processing application, file 210, collaboration feature 220D, action hub 230, status information 236D, collaborator information 238D, and actions 240D, the discussion of the word processing application, file 210, collaboration feature 220D, action hub 230, status information 236D, collaborator information 238D, and actions 240D is exemplary only and should not be considered as limiting. Any suitable number and/or type of applications, files, collaboration features, action hubs, status information, collaborator information, and actions may be utilized in conjunction with the present disclosure.

Referring now to FIG. 2E, one view 200E in a progression of views of a word processing application displayed on a user interface of the client computing device 104, such as a desktop computer, tablet computer or a mobile phone, for example, is shown. The exemplary application, as shown in FIG. 2E, is a word processing application. As illustrated, the exemplary view 200E of the word processing application displayed on the client computing device 104 includes the file 210, a collaboration feature 220E, and the action hub 230. The collaboration feature 220E illustrated in FIG. 2E is the self-identity. As illustrated in FIG. 2E, the collaboration feature 220E (e.g., the self-identity) includes a self-identifier for identifying the current user of the file (e.g., Dani Smith). In this regard, in response to receiving an indication of interest made with respect to the collaboration feature 220E, the action hub 230 may be invoked and displayed within the file 210, as illustrated in FIG. 2E. In one example, an indication of interest may include touching, clicking on, audibly referencing, pointing to, selecting, and/or any indication of an interest in or selection of the collaboration feature 220E. The action hub 230 includes a first portion 232 and a second portion 234. As illustrated in FIG. 2E, the first portion 232 of the action hub 230 is located in a top portion of the action hub 230 and the second portion 234 of the action hub 230 is located in a bottom portion of the action hub 230. The first portion 232 of the action hub 230 includes collaborator information 238E. The collaborator information 238E may include metadata associated with at least one of the collaborator of the file. For example, the collaborator information 238E includes a collaborator image, a collaborator identifier, and contact information. The collaborator identifier illustrated in FIG. 2E is “Dani Smith.” In this regard, Dani Smith is a collaborator/current user of the file 210 associated with the collaboration feature 220E (e.g., the self-identity). As illustrated in FIG. 2E, the indication of interest is made with respect to the self-identity of Dani Smith (e.g., 220E). In some examples, the collaboration feature 220E is the self-identity of a user of the file who may not be collaborating. In other examples, the collaborator information 238E may include metadata associated with a user of the file who may not be collaborating.

As illustrated in FIG. 2E, the second portion 234 of the action hub 230 includes three actions 240E having a contextual relevance to the collaboration feature 220E. In some examples, the action hub 230 includes three or less actions 240E. In this regard, a user of the file 210 may quickly, easily, and efficiently view those actions that are most of relevant to them based on the contextual feature, as well as invoke any actions they may need to take while collaborating within applications. The three actions 240E include About Me, Account Settings, and Go to My Edit Location. In one scenario, as illustrated in FIG. 2E, when the collaboration feature 220E is the self-identity, the one or more actions 240E surfaced in the second portion 234 of the action hub 230 include a collaborator profile action (e.g., About Me), an account action (e.g., Account Settings), and a Go To action (e.g., Go to My Edit Location). In response to receiving a selection of one of the three actions 240E, the selected action may be invoked. For example, in response to receiving a selection of the About Me action, a contact card including contact information associated with the current user/collaborator (e.g., Dani Smith) may be displayed. The contact information may include a phone number, email address, and the like, of the current user. In another example, in response to receiving a selection of the Account Settings action, the account settings associated with the current user (e.g., Dani Smith) may be displayed. In some cases, the account action may include Switch Accounts action. The switch accounts action may allow a user to switch accounts. In yet another example, in response to receiving a selection of the Go to My Edit Location action, the word processing application may change the display of the file 210 such that the location in the file 210 where the current user (e.g., Dani Smith) is editing is displayed and viewable by the user of the file 210.

It is appreciated that while FIG. 2E illustrates the word processing application, file 210, collaboration feature 220E, action hub 230, collaborator information 238E, and actions 240E, the discussion of the word processing application, file 210, collaboration feature 220E, action hub 230, status information 236E, collaborator information 238E, and actions 240E is exemplary only and should not be considered as limiting. Any suitable number and/or type of applications, files, collaboration features, action hubs, status information, collaborator information, and actions may be utilized in conjunction with the present disclosure.

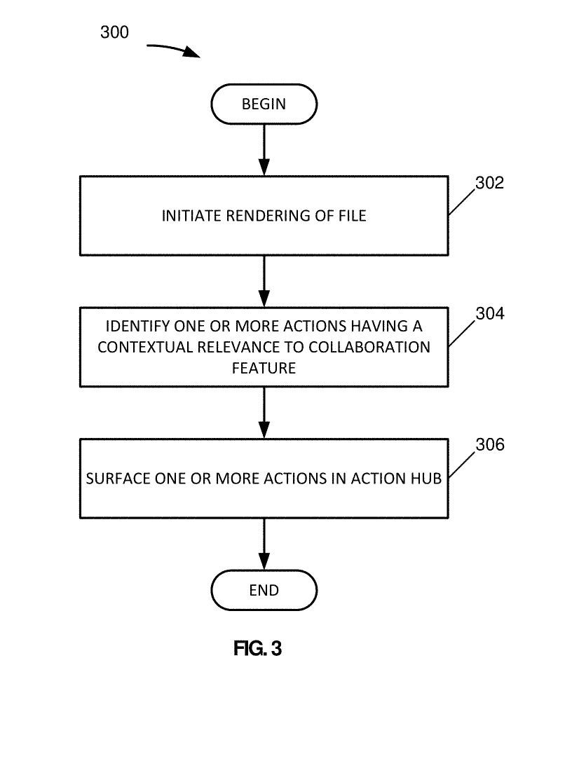

Referring now to FIG. 3, an exemplary method 300 for providing contextual actions from collaboration features, according to an example aspect is shown. Method 300 may be implemented on a computing device or a similar electronic device capable of executing instructions through at least one processor. For example, the software application may be one of an email application, a social networking application, project management application, a collaboration application, an enterprise management application, a messaging application, a word processing application, a spreadsheet application, a database application, a presentation application, a contacts application, a calendaring application, etc. This list is exemplary only and should not be considered as limiting. Any suitable application for contextual actions from collaboration features may be utilized by method 300, including combinations of the above-listed applications.

Method 300 may begin at operation 302, where rendering of a file created with an application on a user interface is initiated. In one example, the file may be rendered on a client computing device. In one example, an application may include any application suitable for collaboration and/or co-authoring such as a word processing application, spreadsheet application, electronic slide presentation application, email application, chat application, voice application, and the like. In one case, a file associated with and/or created with the application may include a word document, a spreadsheet, an electronic slide presentation, an email, a chat conversation, and the like. In one example, the file may include at least one collaboration feature. The one collaboration feature may include at least one of a collaborator gallery, a share list, a comment, an activity, a chat, and a self-identity

When the file created with an application is rendered on a user interface, flow proceeds to operation 304 where one or more actions having a contextual relevance to the at least one collaboration feature are identified. In one example, the one or more actions having a contextual relevance to the at least one collaboration feature are identified in response to receiving an indication of interest with respect to the at least one collaboration feature. The one or more actions having a contextual relevance to the at least one collaboration feature are those actions that are related to and/or specific to a collaboration feature. For example, an action that a user/collaborator of the file would want to take relative to a collaboration feature may be related to and/or specific to the collaboration feature. In one example, the one or more actions having a contextual relevance to the at least one collaboration feature identified may be based on whether the collaborator associated with the at least one collaboration feature is active in the file. For example, a first set of actions may be identified when the collaborator associated with the at least one collaboration feature is active in the file. In another example, a second set of actions may be identified when the collaborator associated with the at least one collaboration feature is not active in the file.

When one or more actions having a contextual relevance to the at least one collaboration feature are identified, flow proceeds to operation 306 where the one or more identified actions are surfaced in an action hub. In one case, the one or more actions include at least one of a communication action, an edit action, a collaborator profile action, a permissions action, a filter action, and an account action. In one example, the one or more identified actions are surfaced within a first portion of the action hub. In another example, the one or more identified actions are surfaced within a second portion of the action hub. In one case, the first portion of the action hub is located in a top portion of the action hub and the second portion of the action hub is located in a bottom portion of the action hub. In one example, the one or more actions surfaced in the action hub includes three or less actions.

The term rendering as used herein generally refers to the various capabilities employed in various computing architectures to assemble information that can then be used by other capabilities to generate an image or images. Within the context of method 300, for example, rendering a file, for example, generally refers to assembling the information or data used to generate an image or images that together result in the file including collaboration features. Animation or other dynamics may also be used to achieve certain effects.

However, it may be appreciated that other perspectives on rendering may be considered within the scope of the present disclosure. For example, rendering as used herein may also, in some scenarios, be considered to refer to the various capabilities employed by various computing architectures to generate an image or images from information assembled for that purpose. With respect to the method 300, rendering a file may refer to generating an image or images, from information assembled for that purpose, that together result in the file, which can then be displayed.

It may also be appreciated that rendering in some scenarios may refer to a combination of the aforementioned possibilities. For example, rendering in some scenarios may refer to both assembling the information used to generate an image or images for a file and then generating the image or images of the file. In addition, a wide variety of other steps, processes, and stages may occur within the context of presenting views of an application, all of which may be considered part of presenting a view. Thus, yet one other variation on method 300 includes, but is not limited to, presenting a file on a user interface, identifying one or more actions, and presenting the one or more actions in an action hub.

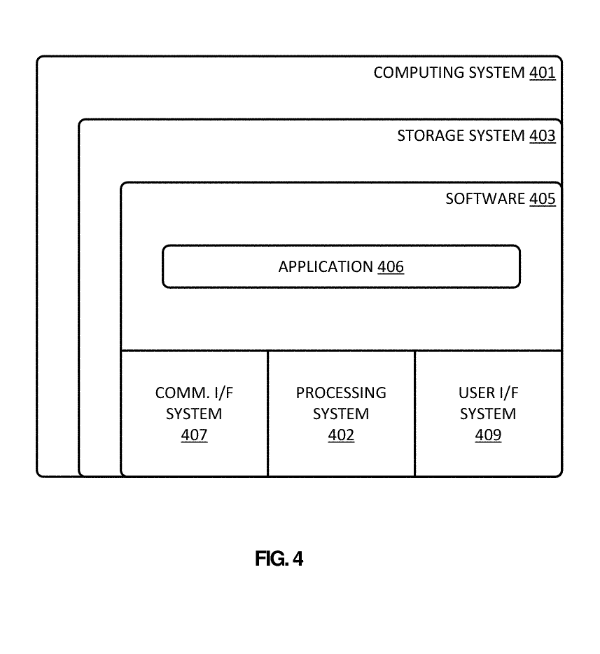

FIG. 4 illustrates computing system 401 that is representative of any system or collection of systems in which the various applications, services, scenarios, and processes disclosed herein may be implemented. Examples of computing system 401 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 401 may be implemented as a single apparatus, system, or device or may be implemented in a distributed manner as multiple apparatuses, systems, or devices. Computing system 401 includes, but is not limited to, processing system 402, storage system 403, software 405, communication interface system 407, and user interface system 409. Processing system 402 is operatively coupled with storage system 403, communication interface system 407, and user interface system 409.

Processing system 402 loads and executes software 405 from storage system 403. Software 405 includes application 406, which is representative of the applications discussed with respect to the preceding FIGS. 1-3, including word processing applications described herein. When executed by processing system 402 to enhance collaboration, software 405 directs processing system 402 to operate as described herein for at least the various processes, operational scenarios, and sequences discussed in the foregoing implementations. Computing system 401 may optionally include additional devices, features, or functionality not discussed for purposes of brevity.

Referring still to FIG. 4, processing system 402 may comprise a micro-processor and other circuitry that retrieves and executes software 405 from storage system 403. Processing system 402 may be implemented within a single processing device, but may also be distributed across multiple processing devices or sub-systems that cooperate in executing program instructions. Examples of processing system 402 include general purpose central processing units, application specific processors, and logic devices, as well as any other type of processing device, combinations, or variations thereof.

Storage system 403 may comprise any computer readable storage media readable by processing system 402 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 403 may also include computer readable communication media over which at least some of software 405 may be communicated internally or externally. Storage system 403 may be implemented as a single storage device, but may also be implemented across multiple storage devices or sub-systems co-located or distributed relative to each other. Storage system 403 may comprise additional elements, such as a controller, capable of communicating with processing system 402 or possibly other systems.

Software 405 may be implemented in program instructions and among other functions may, when executed by processing system 402, direct processing system 402 to operate as described with respect to the various operational scenarios, sequences, and processes illustrated herein. For example, software 405 may include program instructions for implementing enhanced application collaboration.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 405 may include additional processes, programs, or components, such as operating system software, virtual machine software, or other application software, in addition to or that include application 406. Software 405 may also comprise firmware or some other form of machine-readable processing instructions executable by processing system 402.

In general, software 405 may, when loaded into processing system 402 and executed, transform a suitable apparatus, system, or device (of which computing system 401 is representative) overall from a general-purpose computing system into a special-purpose computing system customized to facilitate enhanced application collaboration. Indeed, encoding software 405 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-storage media are characterized as primary or secondary storage, as well as other factors.

For example, if the computer readable storage media are implemented as semiconductor-based memory, software 405 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 407 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 409 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 409. In some cases, the input and output devices may be combined in a single device, such as a display capable of displaying images and receiving touch gestures. The aforementioned user input and output devices are well known in the art and need not be discussed at length here.

User interface system 409 may also include associated user interface software executable by processing system 402 in support of the various user input and output devices discussed above. Separately or in conjunction with each other and other hardware and software elements, the user interface software and user interface devices may support a graphical user interface, a natural user interface, or any other type of user interface.

Communication between computing system 401 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising one or more computer readable storage media; and program instructions stored on the one or more computer readable storage media that, when executed by at least one processor, cause the at least one processor to at least: initiate rendering of file created with a collaboration application in a user interface, the file including at least one collaboration feature; surface at least one of collaborator information and status information in a first portion of an action hub; and surface one or more actions having a contextual relevance to the at least one collaboration feature in a second portion of the action hub, wherein the action hub is displayed proximal to the at least one collaboration feature. In further examples, the first portion of the action hub is located in a top portion of the action hub and the second portion of the action hub is located in a bottom portion of the action hub. In further examples, the at least one collaboration feature includes at least one of a collaborator gallery, a share list, a comment, an activity, a chat, and a self-identity. In further examples, the one or more actions include at least one of a communication action, an edit action, a collaborator profile action, a permissions action, a filter action, and an account action. In further examples, when the at least one collaboration feature is the collaborator gallery, the one or more actions surfaced in the second portion of the action hub include a communication action, an edit action, and a collaborator profile action. In further examples, when the at least one collaboration feature is the share list, the one or more actions surfaced in the second portion of the action hub include a communication action, a permissions action, and a collaborator profile action. In further examples, when the at least one collaboration feature is the comment, the one or more actions surfaced in the second portion of the action hub include a communication action and a collaborator profile action. In further examples, when the at least one collaboration feature is the activity, the one or more actions surfaced in the second portion of the action hub include a communication action, a filter action, and a collaborator profile action. In further examples, when the at least one collaboration feature is the chat, the one or more actions surfaced in the second portion of the action hub include a collaborator profile action. In further examples, when the at least one collaboration feature is the self-identity, the one or more actions surfaced in the second portion of the action hub include an account action, an edit action, and a collaborator profile action.

Further aspects disclosed herein provide an exemplary computer-implemented method for providing contextual actions from collaboration features, the method comprising: initiating rendering of file created with an application in a user interface, the file including at least one collaboration feature; in response to receiving an indication of interest made with respect to the at least one collaboration feature, identifying one or more actions having a contextual relevance to the at least one collaboration feature; and surfacing the one or more identified actions in an action hub. In further examples, the computer-implemented method further comprises surfacing collaborator information and status information in the action hub. In further examples, the collaborator information includes at least a collaborator image and a collaborator identifier. In further examples, the status information includes at least one of a sharing status and an editing status. In further examples, the computer-implemented method further comprises in response to receiving a selection of one of the one or more actions, invoking the selected action. In further examples, the one or more actions surfaced in the action hub includes three or less actions.

Additional aspects disclosed herein provide an exemplary computing apparatus comprising: one or more computer readable storage media; and a collaboration application embodied at least in part in program instructions stored on the one or more computer readable storage media and comprising: a file in a user interface for collaborating among a plurality of collaborators of the file; a first collaboration feature in the user interface through which to present at least metadata associated with at least one of the collaborators of the plurality of collaborators of the file and through which to receive an indication of interest made with respect to the first collaboration feature; and a first action hub in the user interface through which to, in response to the indication of interest made with respect to the first collaboration feature, surface one or more actions having a contextual relevance to the first collaboration feature. In further examples, the collaboration application further comprises: a second collaboration feature in the user interface through which to present at least metadata associated with at least one of the collaborators of the plurality of collaborators of the file and through which to receive an indication of interest made with respect to the second collaboration feature; and a second action hub in the user interface through which to, in response to the indication of interest made with respect to the second collaboration feature, surface one or more actions having a contextual relevance to the second collaboration feature. In further examples, at least one of the one or more actions having a contextual relevance to the first collaboration feature is different from at least one of the one or more actions having a contextual relevant to the second collaboration feature. In further examples, the first collaboration feature and the second collaboration feature are associated with the file in the user interface, wherein the first action hub is displayed proximal to the first collaboration feature within the file in the user interface, and wherein the second action hub is displayed proximal to the second collaboration feature within the file in the user interface.

Techniques for providing contextual actions from collaboration features are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of action hub systems that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
one or more computer readable storage media; and
program instructions stored on the one or more computer readable storage media that, when executed by at least one processor, cause the at least one processor to at least:
initiate rendering of file created with a collaboration application in a user interface, the file including at least one collaboration feature;
surface at least one of collaborator information and status information in a first portion of an action hub; and
surface one or more actions having a contextual relevance to the at least one collaboration feature in a second portion of the action hub, wherein the action hub is displayed proximal to the at least one collaboration feature.

2. The system of claim 1, wherein the first portion of the action hub is located in a top portion of the action hub and the second portion of the action hub is located in a bottom portion of the action hub.

3. The system of claim 1, wherein the at least one collaboration feature includes at least one of a collaborator gallery, a share list, a comment, an activity, a chat, and a self-identity.

4. The system of claim 1, wherein the one or more actions include at least one of a communication action, an edit action, a collaborator profile action, a permissions action, a filter action, and an account action.

5. The system of claim 3, wherein when the at least one collaboration feature is the collaborator gallery, the one or more actions surfaced in the second portion of the action hub include a communication action, an edit action, and a collaborator profile action.

6. The system of claim 3, wherein when the at least one collaboration feature is the share list, the one or more actions surfaced in the second portion of the action hub include a communication action, a permissions action, and a collaborator profile action.

7. The system of claim 3, wherein when the at least one collaboration feature is the comment, the one or more actions surfaced in the second portion of the action hub include a communication action and a collaborator profile action.

8. The system of claim 3, wherein when the at least one collaboration feature is the activity, the one or more actions surfaced in the second portion of the action hub include a communication action, a filter action, and a collaborator profile action.

9. The system of claim 3, wherein when the at least one collaboration feature is the chat, the one or more actions surfaced in the second portion of the action hub include a collaborator profile action.

10. The system of claim 3, wherein when the at least one collaboration feature is the self-identity, the one or more actions surfaced in the second portion of the action hub include an account action, an edit action, and a collaborator profile action.

11. A computer-implemented method for providing contextual actions from collaboration features, the method comprising:
initiating rendering of file created with an application in a user interface, the file including at least one collaboration feature;
in response to receiving an indication of interest made with respect to the at least one collaboration feature, identifying one or more actions having a contextual relevance to the at least one collaboration feature; and
surfacing the one or more identified actions in an action hub.

12. The computer-implemented method of claim 11, further comprising surfacing collaborator information and status information in the action hub.

13. The computer-implemented method of claim 12, wherein the collaborator information includes at least a collaborator image and a collaborator identifier.

14. The computer-implemented method of claim 12, wherein the status information includes at least one of a sharing status and an editing status.

15. The computer-implemented method of claim 11, further comprising in response to receiving a selection of one of the one or more actions, invoking the selected action.

16. The computer-implemented method of claim 11, wherein the one or more actions surfaced in the action hub includes three or less actions.

17. A computing apparatus comprising:
one or more computer readable storage media; and
a collaboration application embodied at least in part in program instructions stored on the one or more computer readable storage media and comprising:
a file in a user interface for collaborating among a plurality of collaborators of the file;
a first collaboration feature in the user interface through which to present at least metadata associated with at least one of the collaborators of the plurality of collaborators of the file and through which to receive an indication of interest made with respect to the first collaboration feature; and
a first action hub in the user interface through which to, in response to the indication of interest made with respect to the first collaboration feature, surface one or more actions having a contextual relevance to the first collaboration feature.

18. The computing apparatus of claim 17, wherein the collaboration application further comprises:
a second collaboration feature in the user interface through which to present at least metadata associated with at least one of the collaborators of the plurality of collaborators of the file and through which to receive an indication of interest made with respect to the second collaboration feature; and
a second action hub in the user interface through which to, in response to the indication of interest made with respect to the second collaboration feature, surface one or more actions having a contextual relevance to the second collaboration feature.

19. The computing apparatus of claim 18, wherein at least one of the one or more actions having a contextual relevance to the first collaboration feature is different from at least one of the one or more actions having a contextual relevant to the second collaboration feature.

20. The computing apparatus of claim 17, wherein the first collaboration feature and the second collaboration feature are associated with the file in the user interface, wherein the first action hub is displayed proximal to the first collaboration feature within the file in the user interface, and wherein the second action hub is displayed proximal to the second collaboration feature within the file in the user interface.
